(19) United States
(12) Patent Application Publication
(10) Pub. No.: US 2021/0143584 A1
(43) Pub. Date: May 13, 2021

(54) CONNECTOR STRUCTURE

(71) Applicant: YAZAKI CORPORATION, Tokyo (JP)

(72) Inventors: Tomoyuki Miyakawa, Makinohara-shi (JP); Kozo Oishi, Utsunomiya-shi (JP); Rina Sakai, Utsunomiya-shi (JP)

(21) Appl. No.: 17/094,799

(22) Filed: Nov. 10, 2020

(30) Foreign Application Priority Data
Nov. 12, 2019 (JP) 2019-204680

(51) Int. Cl. H01R 13/645

(52) U.S. Cl. CPC H01R 13/6456; H01R 13/6272

(57) ABSTRACT

A connector structure includes a first connector and a second connector. One connector among the first and second connector has a number of convex parts projected toward another one connector of the first and second connector in their fitting direction, and the convex parts each has an opening region communicating with a terminal housing chamber belonging to the one connector. The another one connector has a number of concave parts recessed away from the one connecter in the fitting direction, and the concave parts each has an opening region communicating with a terminal housing chamber belonging to the another one connector. Each of outer circumferential surfaces of the convex parts is in contact with each of inner circumferential surfaces of the concave parts when the first connector and the second connector are fitted to each other.

### CROSS-REFERENCE TO RELATED APPLICATIONS

This application is based on and claims priority under 35 USC 119 from Japanese Patent Application No. 2019-204680 filed on Nov. 12, 2019, the contents of which are incorporated herein by reference.

### TECHNICAL FIELD

The present invention relates to a connector structure including: first connector; and second connector configured to fit to the first connector in a preset fitting direction.

### BACKGROUND ART

In recent, a connector structure in which a pair of connectors are fitted to each other has been proposed. In one of such connector structures, in order to provide the connector structure with a waterproof function, for example, a packing is attached to one of connectors, and, when the connectors are fitted to each other, the other connector is in press contact with the packing.

As for details of the above connector structure, refer to JP 2005-346940 A.

In the above connector structure, the waterproof performance of the connector structure is enhanced by using a packing. In the case where water enters from the outside into a connector structure due to a reason such as deterioration of a packing, however, there arises a possibility that a short circuit through the water may be caused between adjacent terminal housing chambers (namely, between a terminal housed in a certain terminal housing chamber, and another terminal housed in another terminal housing chamber). Such a short circuit may block normal operation of an electronic apparatus or the like that uses a connector structure. Therefore, it is preferable to suppress such a short circuit as far as possible.

### SUMMARY OF INVENTION

Aspect of non-limiting embodiments of the present disclosure relates to provide a connector structure in which the waterproof performance between a plurality of terminal housing chambers can be improved. Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a connector structure comprising:

a first connector; and

a second connector configured to fit to the first connector in a fitting direction,

one connector among the first connector and the second connector having a plurality of convex parts projected toward another one connector of the first connector and the second connector in the fitting direction, and the convex parts each having a first opening region communicating with a first terminal housing chamber belonging to the one connector,

the another one connector having a plurality of concave parts recessed away from the one connecter in the fitting direction, and the concave parts each having a second opening region communicating with a second terminal housing chamber belonging to the another one connector,

each of outer circumferential surfaces of the plurality of the convex parts being in contact with each of inner circumferential surfaces of the plurality of the concave parts upon the first connector and the second connector being fitted to each other.

### BRIEF DESCRIPTION OF DRAWINGS

Exemplary embodiment(s) of the present invention will be described in detail based on the following Figures, wherein:

FIG. 1 is a perspective view showing a state where male and female connectors disposed in a connector structure according to an exemplary embodiment of the present invention have not been fitted to each other;

FIG. 2 is an exploded perspective view of a female housing disposed in the female connector shown in FIG. 1;

FIG. 3A is a front view of a male housing disposed in the male connector shown in FIG. 1, and FIG. 3B is a section view taken along line A-A in FIG. 3A;

FIGS. 4A and 4B show the connector structure in the state where a fitting between the male and female connectors has been completed, FIG. 4A is a top view of the structure, and FIG. 4B is a side view of the structure;

FIG. 5A is a section view taken along line B-B in FIG. 4B, and FIG. 5B is a section view taken along line C-C in FIG. 4A; and

FIG. 6 is a section view taken along line D-D in FIG. 5A.

### DESCRIPTION OF EMBODIMENTS

Hereinafter, a connector structure 3 of an embodiment of the invention will be described with reference to the drawings. As shown in FIG. 1, the connector structure 3 includes a male connector 1 and a female connector 2. In the connector structure 3, when a male housing 10 disposed in the male connector 1, and a female housing 20 disposed in the female connector 2 are fitted to each other, electric wires 4 connected to male terminals (not shown) that are housed in the male housing 10, and electric wires 5 connected to female terminals (not shown) that are housed in the female housing 20 are electrically connected to each other, respectively.

For the sake of convenience of description, hereinafter, “anteroposterior direction,” “width direction,” “vertical direction.” “upper,” and “lower” are defined as shown in FIG. 1. “Anteroposterior direction,” “width direction,” and “vertical direction” are orthogonal to one another. The anteroposterior direction coincides with the fitting direction of the male connector 1 (male housing 10) and the female connector 2 (female housing 20), the insertion direction in which the male terminals are inserted into the male housing 10, and the insertion direction in which the female terminals are inserted into the female housing 20. In each of the male connector 1 and the female connector 2, it is assumed that the front side in the fitting direction in which the counter connector is to be fitted is the front side, and the opposite or back side in the fitting direction is the rear side. Hereinafter, the male connector 1 will be first described.

As shown in FIG. 1, the male connector 1 is configured by the resin-made male housing 10, and the pair of male terminals (not shown) that are housed in the male housing 10. As shown in FIGS. 1, 3B, 5A, and 5B, the male housing 10 integrally includes a terminal housing portion 11 that elongates in the anteroposterior direction, and that has a substantially rectangular parallelepiped shape, and a hood portion 12 that forward elongates from the terminal housing portion 11.

In the terminal housing portion 11, a pair of terminal housing chambers 13 (see FIGS. 5A and 5B) that pass through the portion in the anteroposterior direction are formed so as to be juxtaposed in the width direction. The hood portion 12 has a tubular shape that is forward projected while enclosing front end parts of the pair of terminal housing chambers 13, and that forward opens. The bottom surface of the hood portion 12 functions also as the front end surface of the terminal housing portion 11.

In the front end surface (i.e., the bottom surface of the hood portion 12) of the terminal housing portion 11, as shown in FIG. 3B, a pair of concave parts 14 are formed so as to be juxtaposed in the width direction in correspondence with the pair of terminal housing chambers 13. In the embodiment, the concave parts 14 are columnar recesses that are rearward recessed. Opening parts 15 that communicate with the terminal housing chambers 13 are formed in the bottom surfaces of the concave parts 14, respectively. When the male connector 1 and the female connector 2 are fitted to each other (hereinafter, this state is sometimes referred to merely as “in fitting”), a pair of convex parts 27 that are in the female housing 20, and that will be described later are fitted into the pair of concave parts 14, respectively.

The pair of male terminals to which the electric wires 4 are connected are inserted from the rear side into the pair of terminal housing chambers 13 to be housed therein, respectively. In a stage where the process of housing the male terminals is halfway, lances 13a (see FIG. 5B) that are disposed on the terminal housing chambers 13 are elastically deformed in a direction separating from the male terminals, and, in that where the process of housing the male terminals is completed, the lances are elastically restored in a direction approaching toward the male terminals to be engaged with predetermined step parts of the male terminals, respectively. This prevents the male terminals from rearward slipping off from the male housing 10. In the stage where the process of housing the male terminals is completed, tab parts (not shown) of the pair of male terminals are forward projected from the front end surface of the terminal housing portion 11 (more correctly, the opening parts 15 of the pair of concave parts 14), and located in the internal space of the hood portion 12.

As shown in FIGS. 1, 4A, and 6, a lock arm 16 (see FIG. 1) is formed in the middle portion in the width direction of the upper part of the hood portion 12. In fitting, the lock arm 16 is engaged with a lock beak 25 (see FIGS. 1, 2, and 6) that is formed on the female housing 20, and that will be described later, whereby the male housing 10 and the female housing 20 are maintained in the fitting completed state.

Next, the female connector 2 will be described. As shown in FIGS. 1, 2, 5A, and 5B, the female connector 2 is configured by the resin-made female housing 20 and the pair of female terminals (not shown). As shown in FIG. 2, the female housing 20 includes a terminal housing portion 21 that elongates in the anteroposterior direction, and that has a substantially rectangular parallelepiped shape, and a pair of tubular members 22 that are attached to the terminal housing portion 21.

In the terminal housing portion 21, a pair of tubular-member housing chambers 23 (see FIGS. 5A and 5B) that pass through the portion in the anteroposterior direction are formed so as to be juxtaposed in the width direction. In the embodiment, the inner circumference (of the section perpendicular to the anteroposterior direction) of each of the tubular-member housing chambers 23 has a rectangular shape in which the four corners are rounded. The pair of tubular members 22 are inserted from the front side into the pair of tubular-member hosing chambers 23, respectively.

As shown in FIGS. 1, 2, and 5B, a pair of engaging holes 24 are formed in the middle portion in the anteroposterior direction of each of the upper and lower walls of the terminal housing portion 21 in correspondence with the pair of tubular-member housing chambers 23. The engaging holes 24 vertically pass through the walls to communicate with the corresponding tubular-member housing chambers 23. As shown in FIGS. 1, 2, and 6, the lock beak 25 that is upward projected is formed in the middle portion in the width direction of the part of the upper surface of the terminal housing portion 21 that is in front of the engaging holes 24.

As shown in FIG. 2, each of the tubular members 22 has a tubular shape that elongates in the anteroposterior direction, and its outer circumference (of the section perpendicular to the anteroposterior direction) has a shape that corresponds to the above-described inner circumferential shape of the corresponding tubular-member housing chamber 23. In each of the tubular members 22, as shown in FIGS. 5A and 5B, a single terminal housing chamber 26 that passes through the member in the anteroposterior direction is formed.

The convex part 27 that is forward projected is formed integrally with the front end of each of the tubular members 22. In the embodiment, the convex part 27 has a columnar shape that elongates in the anteroposterior direction. The convex part 27 is projected radially outward from the whole circumference of the tubular member 22 (toward the outer side in a direction perpendicular to the anteroposterior direction). Therefore, a step 28 is formed in the boundary between the convex part 27 and the front end of the tubular member 22.

In each of the convex parts 27, an opening part 29 that communicates with the corresponding terminal housing chamber 26, and that passes through the convex part in the anteroposterior direction is formed. In fitting, the tab part of the corresponding male terminal is inserted into the terminal housing chamber 26 through the opening part 29. As shown in FIGS. 2 and 5B, a projection 31 is formed in correspondence with the corresponding engaging hole 24 of the terminal housing portion 21, in the middle portion in the anteroposterior direction of each of the upper and lower surfaces of the tubular member 22.

A process of assembling the female housing 20 is completed by, as shown in FIGS. 5A and 5B, inserting from the front side the pair of tubular members 22 into the pair of tubular-member housing chambers 23 of the terminal housing portion 21, respectively until the steps 28 butt against the front end surface of the terminal housing portion 21. In the assembly completed state of the female housing 20, as shown in FIG. 5B, the projections 31 of the tubular members 22 are engaged with the front edges of the engaging holes 24 of the terminal housing portion 21, respectively, whereby the tubular members 22 are prevented from forward slipping off from the terminal housing portion 21. In the assembly completed state of the female housing 20, as shown in FIG. 1, the pair of convex parts 27 are projected from the front end surface of the terminal housing portion 21 (see FIG. 1).

In the assembly completed state of the female housing 20, annular gaps exist between the inner wall surfaces of the tubular-member housing chambers 23 into which the tubular members 22 are inserted, respectively, and the outer wall surfaces of the tubular members 22, and therefore each of the tubular members 22 is relatively movable with respect to the terminal housing portion 21 by a small distance in a radial direction (direction perpendicular to the anteroposterior direction). Therefore, one of the convex parts 27 is independent from the other convex part 27, and relatively movable with respect to the terminal housing portion 21 (female housing 20) by a small distance in a radial direction (direction perpendicular to the anteroposterior direction).

The pair of female terminals to which the electric wires 5 (see FIG. 1) are connected are inserted from the rear side into the terminal housing chambers 26 of the pair of tubular members 22 to be housed therein, respectively. In a stage where the process of housing the female terminals is halfway, lances 26a (see FIG. 5B) that are disposed on the terminal housing chambers 26 are elastically deformed in a direction separating from the female terminals, and, in that where the process of housing the female terminals is completed, the lances are elastically restored in a direction approaching toward the female terminals to be engaged with predetermined step parts (not shown) of the female terminals, respectively. Therefore, the female terminals are prevented from rearward slipping off from the tubular members 22.

As shown in FIGS. 5A and 5B, the fitting between the male housing 10 and the female housing 20 is achieved by: inserting the terminal housing portion 21 of the female housing 20 into the hood portion 12 of the male housing 10; fitting the pair of convex parts 27 that are forward projected from the terminal housing portion 21, into the pair of concave parts 14 of the male housing 10; and butting the front end surface of the terminal housing portion 21, and the front end surface (the bottom surface of the hood portion 12) of the terminal housing portion 11 of the male housing 10 against each other.

In the state where the fitting between the male housing 10 and the female housing 20 is completed, the tab parts of the male terminals that are housed in the male housing 10 are inserted into tubular box parts (not shown) of the female terminals that are housed in the female housing 20. Therefore, the electric wires 4 (see FIG. 1) connected to the male terminals, and the electric wires 5 (see FIG. 1) connected to the female terminals are electrically connected to each other, respectively.

Moreover, the lock arm 16 (see FIG. 1) formed on the male housing 10 is engaged with the lock beak 25 (see FIGS. 1 and 2) formed on the female housing 20 (see FIG. 6). Therefore, the male housing 10 and the female housing 20 are maintained in the fitting completed state.

Furthermore, the pair of convex parts 27 are fitted into the pair of concave parts 14, respectively, and therefore the outer circumferential surface (tube outer circumferential surface) of each of the pair of convex parts 27, and the inner circumferential surface (tube inner circumferential surface) of each of the pair of concave parts 14 are in contact with each other as shown in FIG. 6. Therefore, the corresponding terminal housing chambers 13, 26 are sealed together (or the creepage distance is prolonged), whereby the waterproof performance between the terminal housing chambers 13, 26 that are in one side in the width direction, and the terminal housing chambers 13, 26 that are in the other side in the width direction is improved.

Each of the convex parts 27, and each of the concave parts 14 may be placed so that the inner circumferential surface of the concave part 14 and the outer circumferential surface of the convex part 27 are in complete contact with each other, or may be placed so that the inner circumferential surface of the concave part 14 and the outer circumferential surface of the convex part 27 are partially in contact with each other, and gaps are formed in the other parts.

Moreover, each of the convex parts 27 is independent from the other convex part 27, and relatively movable with respect to the terminal housing portion 21 (female housing 20) by a small distance in a radial direction. Therefore, a positional displacement (axial displacement) of each of the convex parts 27 due to the manufacturing tolerance or the like can be absorbed by a movement of the convex part 27 itself. This can prevent the waterproof performance from being lowered due to a positional displacement of the convex part 27.

According to the connector structure 3 of the embodiment of the invention, when the male connector 1 and the female connector 2 are fitted to each other, the outer circumferential surface of each of the plurality of convex parts 27, and the inner circumferential surface of each of the plurality of concave parts 14 are in contact with each other. Therefore, the terminal housing chambers 13, 26 corresponding to one of the convex part 27 and the concave part 14 are sealed together (or the creepage distance is prolonged), whereby the waterproof performance between the terminal housing chambers 13, 26 and the terminal housing chambers 13, 26 corresponding to the other of the convex part 27 and the concave part 14 is improved. In the connector structure 3 of the embodiment, therefore, it is possible to improve the waterproof performances among a plurality of pairs of terminal housing chambers.

According to the connector structure 3 of the embodiment, moreover, each of the convex parts 27 is independent from the other convex part 27, and relatively movable with respect to the terminal housing portion 21 (female housing 20) by a small distance in a radial direction. Therefore, a positional displacement (axial displacement) of each of the convex parts 27 due to the manufacturing tolerance or the like can be absorbed by a movement of the convex part 27 itself. This can prevent the waterproof performance from being lowered due to a positional displacement of the convex part 27.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

In the embodiment, in the female housing 20, the pair of tubular members 22 having the pair of convex parts 27 are formed separately from the terminal housing portion 21, and assembled to the terminal housing portion 21 in a mutually independent manner. Therefore, each of the convex parts 27 is independent from the other convex part 27, and relatively movable with respect to the terminal housing portion 21 (female housing 20) by a small distance in a radial direction. On the other hand, in the male housing 10, the pair of concave parts 14 are formed integrally with the terminal housing portion 11, and therefore the concave parts 14 are not relatively movable with respect to the terminal housing portion 11 (male housing 10) in a radial direction.

In the male housing 10, by contrast, the pair of components having the pair of concave parts 14 may be formed separately from the terminal housing portion 11, and assembled to the terminal housing portion 11 in a mutually independent manner, whereby each of the concave parts 14 may be independent from the other concave pars 14, and relatively movable with respect to the terminal housing portion 11 (male housing 10) by a small distance in a radial direction. Namely, the concave parts 14 may be relatively movable with respect to the terminal housing portion 11, and the convex parts 27 may be relatively movable with respect to the terminal housing portion 21.

In the female housing 20, furthermore, the pair of convex parts 27 may be formed integrally with the terminal housing portion 21, and the convex parts 27 may not be relatively movable with respect to the terminal housing portion 21 (female housing 20) in a radial direction. Namely, the concave parts 14 may not be relatively movable with respect to the terminal housing portion 11, and the convex parts 27 may not be relatively movable with respect to the terminal housing portion 21.

In the embodiment, the female housing 20 includes the pair of convex parts 27 (the pair of terminal housing chambers 26), and the male housing 10 includes the pair of concave parts 14 (the pair of terminal housing chambers 13). By contrast, the female housing 20 may include a predetermined number (three or more) of convex parts 27 (the predetermined number of terminal housing chambers 26), and the male housing 10 may include concave parts 14 the number of which is equal to the predetermined number (terminal housing chambers 13 the number of which is equal to the predetermined number).

In the embodiment, moreover, the plurality of concave parts 14 are formed in the male housing 10, and the plurality of convex parts 27 are formed in the female housing 20. By contrast, a plurality of convex parts may be formed in the male housing 10, and a plurality of concave parts may be formed in the female housing 20.

According to the above exemplary embodiments, the connector structure (3) comprises: a first connector (1); and a second connector (2) configured to fit to the first connector (1) in a fitting direction.

One connector (2) among the first connector (1) and the second connector (2) has a plurality of convex parts (27) projected toward another one connector (1) of the first connector (1) and the second connector (2) in the fitting direction, and the convex parts (27) each has a first opening region (29) communicating with a first terminal housing (26) chamber belonging to the one connector (2).

The another one connector (1) has a plurality of concave parts (14) recessed away from the one connecter (2) in the fitting direction, and the concave parts (14) each has a second opening region (15) communicating with a second terminal housing chamber (13) belonging to the another one connector (1).

Each of outer circumferential surfaces of the plurality of the convex parts (27) is in contact with each of inner circumferential surfaces of the plurality of the concave parts (14) upon the first connector (1) and the second connector (2) are fitted to each other.

According to the thus configured connector structure, when the first connector and the second connector are fitted to each other, the outer circumferential surface of each of the plurality of the convex parts and the inner circumferential surface of each of the pair of concave parts are in contact with each other. Therefore, the gap between the terminal housing chamber corresponding to one of the convex parts and one of the concave parts, and that corresponding to another of the convex parts and another of the concave parts is sealed together (or the creepage distance is prolonged). Even in the case where water enters into the connector structure, therefore, a short circuit between adjacent terminal housing chambers is prevented from occurring. In the connector structure having above-described configuration, therefore, the waterproof performance between a plurality of terminal housing chambers can be improved.

The convex and concave portions are requested to have a function in which water leakage from one of the adjacent adjacent terminal housing chambers to the other adjacent terminal housing chamber is suppressed as compared with the case where such a convex and concave structure is not disposed, and are not necessary to have a function for perfectly preventing such water leakage from occurring. In other words, the above-described convex and concave portions may be placed so that the inner circumferential surface and the outer circumferential surface are in complete contact with each other, or may be placed so that the inner circumferential surface and the outer circumferential surface are partially in contact with each other, and gaps are formed in the other parts.

In the above-described connector structure (3), at least one of the plurality of the convex parts (27) may be configured to be independent from other of the plurality of the convex parts (27) and to be relatively movable with respect to the one connector (2) in a first direction intersecting with the fitting direction.

Further, in the above-described connector structure (3), at least one of the plurality of the concave parts (14) may be configured to be independent from other of the plurality of the concave parts (14) and to be relatively movable with respect to the another one connector (1) in a second direction intersecting with the fitting direction.

According to the thus configured connector structure, at least one of the convex parts and concave parts is configured so as to be independent from the other convex or concave parts, and relatively movable with respect to the corresponding connector in a direction intersecting with the fitting direction. Therefore, a positional displacement (axial displacement) of each of the convex parts and concave parts due to the manufacturing tolerance or the like can be absorbed by a movement of the convex or concave part itself. In the connector structure having the above-described configuration, therefore, it is possible to prevent the waterproof performance from being lowered due to a positional displacement of the convex or concave part.

What is claimed is:

1. A connector structure comprising:
a first connector; and
a second connector configured to fit to the first connector in a fitting direction,
one connector among the first connector and the second connector having a plurality of convex parts projected toward another one connector of the first connector and the second connector in the fitting direction, and the convex parts each having a first opening region communicating with a first terminal housing chamber belonging to the one connector,
the another one connector having a plurality of concave parts recessed away from the one connecter in the fitting direction, and the concave parts each having a second opening region communicating with a second terminal housing chamber belonging to the another one connector,
each of outer circumferential surfaces of the plurality of the convex parts being in contact with each of inner circumferential surfaces of the plurality of the concave parts upon the first connector and the second connector being fitted to each other.

2. The connector structure according to claim 1, wherein
at least one of the plurality of the convex parts is independent from other of the plurality of the convex parts and is relatively movable with respect to the one connector in a first direction intersecting with the fitting direction.

3. The connector structure according to claim 1, wherein
at least one of the plurality of the concave parts is independent from other of the plurality of the concave parts and is relatively movable with respect to the another one connector in a second direction intersecting with the fitting direction.
